(19) United States
(12) Patent Application Publication
(10) Pub. No.: US 2017/0109832 A1
(43) Pub. Date: Apr. 20, 2017

(54) METHOD TO DETECT CASH EQUIVALENT DEPOSIT STRUCTURING AND FUNNEL ACCOUNT BEHAVIOR

(71) Applicant: Early Warning Services, LLC, Scottsdale, AZ (US)

(72) Inventors: Ronald Scott Alcorn, Austin, TX (US); Jie He, Naperville, IL (US); Steve Fleming, Austin, TX (US); Ravi Loganathan, Charlotte, NC (US); Jeff Parent, Tempe, AZ (US)

(73) Assignee: Early Warning Services, LLC, Scottsdale, AZ (US)

(21) Appl. No.: 15/296,232

(22) Filed: Oct. 18, 2016

Related U.S. Application Data
(60) Provisional application No. 62/243,990, filed on Oct. 20, 2015.

(51) Int. Cl. G06Q 40/00; G06Q 40/02

(52) U.S. Cl. CPC G06Q 40/12; G06Q 40/02

(57) ABSTRACT

Account information is analyzed to identify accounts that have received deposits drawn on accounts associated with money service businesses. When such deposits are detected, other transaction data is analyzed to decide whether or not to categorize the account as suspected of being used for an illicit purpose such as money laundering. The analyzed information may include the number or percentage of deposits received drawn on accounts associated with money services businesses, the pattern of deposits and withdrawals into and from the account, and other information.

### CROSS-REFERENCES TO RELATED APPLICATIONS

This application claims priority to U.S. Provisional Patent Application No. 62/243,990, filed Oct. 20, 2015, entitled “METHOD TO DETECT CASH EQUIVALENT DEPOSIT STRUCTURING AND FUNNEL ACCOUNT BEHAVIOR,” the entire disclosure of which is hereby incorporated by reference, for all purposes, as if fully set forth herein.

### BACKGROUND OF THE INVENTION

Financial institutions may collect large amounts of information on accounts used for transactions. Such information may be used for various purposes, for example to authenticate persons conducting transactions, and to detect the occurrence of transactions that are suspected of being fraudulent. Information may be collected from many sources and in many different forms, and as such it may be difficult to understand how different pieces of information may relate to a specific person or transaction.

In addition, regulatory authorities in many countries including the United States require banks and other financial institutions to conduct a level of due diligence to verify the identities of their customers, in an effort to detect and prevent various kinds of fraud. This diligence is sometimes called a “Know Your Customer” program.

### BRIEF SUMMARY OF THE INVENTION

According to one aspect, a method comprises maintaining one or more computerized databases holding records of a number of deposits into a number of accounts at a number of financial institutions. The records indicate for each of the number of deposits at least the number of an account from which funds were drawn to make the deposit, the number of an account into which the deposit was made, the amount of the deposit, and the date of the deposit. The method further comprises identifying, from the records, accounts that received deposits of funds drawn from accounts associated with one or more money service businesses within a predetermined time period. For each identified account, the method further comprises evaluating whether the deposits received into the account drawn from accounts associated with one or more money service businesses were in even dollar amounts; evaluating the number of deposits in even dollar amounts received into the account within the predetermined time period; and categorizing the account as a suspected funnel account or not a suspected funnel account based at least in part on the evaluations. At least some of the identified accounts are categorized as suspected funnel accounts, and the method further comprises, for at least each account categorized as a suspected funnel account, communicating the result of the categorization.

### BRIEF DESCRIPTION OF THE DRAWINGS

FIG. 1 illustrates a system in accordance with embodiments of the invention.

FIG. 2 illustrates a flow chart of a method in accordance with embodiments of the invention.

FIG. 3 illustrates a flow chart of a method in accordance with other embodiments of the invention.

FIG. 4 illustrates a flow chart of a method in accordance with other embodiments of the invention.

FIG. 5 illustrates a flow chart of a method in accordance with other embodiments of the invention.

FIG. 6 illustrates a block diagram illustrating an exemplary computer system upon which embodiments of the present invention may be implemented.

### DETAILED DESCRIPTION OF THE INVENTION

Embodiments of the invention provide methods and systems for analyzing information about financial transactions involving certain kinds of accounts. Such techniques may be helpful in uncovering fraud such as money laundering, or as part of a Know Your Customer program.

Money laundering is the process of concealing the existence, source, or use of funds, to make the funds appear legitimately obtained or used. While there are many money laundering schemes, some involve such techniques as:
structuring—making deposits in a pattern intended to avoid suspicion, for example breaking up a large deposit into a series of smaller deposits each of which is below a threshold amount for which cash transactions must be reported to authorities;
funnel accounts—a funnel account is defined by the U.S. Treasury Department as an individual or business account in one geographic area that receives multiple cash deposits, often in amounts below the cash reporting threshold, and from which the funds are withdrawn in a different geographic area with little time elapsing between the deposits and withdrawals; and
trade-based money laundering—masking the transfer of money by making it appear to be part of legitimate commercial trade, for example by paying much more or much less for goods than their actual value.

In addition, money service businesses may be employed in an attempt to conceal the source of funds. A money service business (MSB) is defined by the U.S. Treasury Department as a person (other than a bank or an entity regulated by the Securities and Exchange Commission or the Commodity Futures Trading Commission) doing business as a currency dealer or exchanger, a check casher, an issuer of traveler's checks, money orders, or stored value, a seller or redeemer of traveler's checks, money orders, or stored value, a money transmitter, or the U.S. Postal Service. For example, a person wishing to mask the source of funds may provide cash to a money transmitter and then employ the services of the money transmitter to transfer the funds to an account. The resulting account deposit will thus be recorded as having been drawn on the account of the legitimate money transmitter, concealing or at least obfuscating the source from which the money transmitter received the funds. From the point of view of the depository account, funds drawn on an account owned by a money service business may be considered “cash equivalent” funds, because they arrive at the depository account without any indication of their source prior to the transfer by the money service business.

Embodiments of the invention exploit information from a number of sources to uncover suspected fraud such as money laundering by looking for patterns in transactions that, taken individually, may appear to be legitimate. Specifically, embodiments of the invention consider patterns in the use of money service businesses. Embodiments of the invention may also consider patterns in the amounts and timing of deposits and withdrawals to specific accounts.

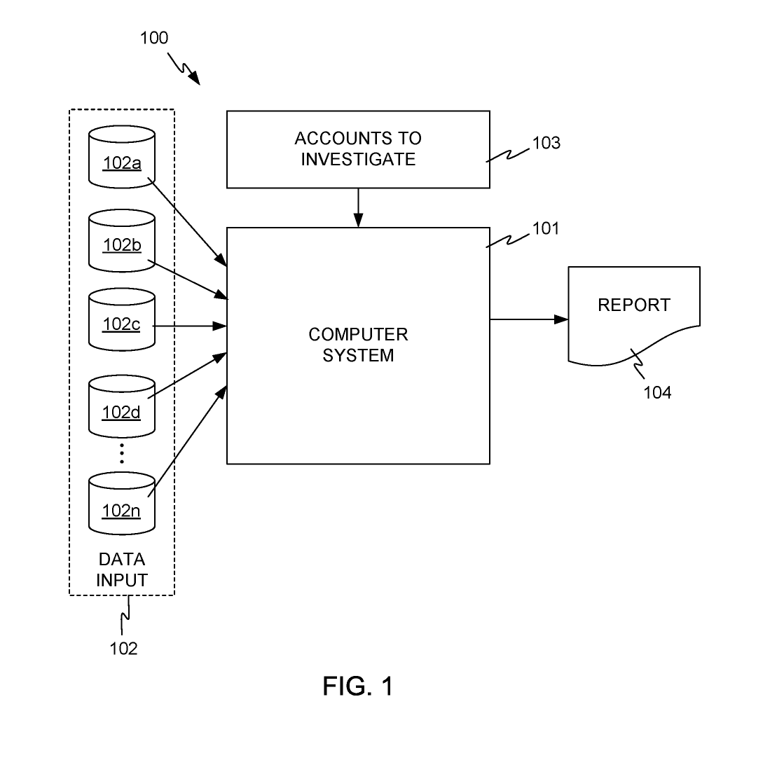

FIG. 1 illustrates a system 100 in accordance with embodiments of the invention. A computer system 101 is coupled to one or more databases 102, holding records of check-based financial transactions and other information. Databases 102 may be organized in any suitable manner. For example, all of the stored information may be considered to be one large database 102, or the information may be considered to be organized into a number of specialized databases. For example, one database 102a may hold a list of check transactions with descriptive data about each check such as the drawee routing and account numbers, the amount of the transaction, the date of the transaction, deposit account information, and status information. Another database 102b may hold a directory of money service businesses, including a cross-reference table that correlates the names of money services businesses with the numbers of accounts they use in conducting their businesses. Another database 102c may correlate bank account numbers with the names of the owners of the accounts. Another database 102d may record the balances of accounts over time. Other databases may hold other information as well.

Preferably, the information in databases 102 is gathered from a number of financial institutions. That is, databases 102 preferably contain records of financial transactions occurring at and between a number of banks or other institutions, and may contain account ownership records for a number of accounts at a number of banks or other institutions.

Computer 101 is specially programmed to use information from databases 102 to identify accounts receiving deposits drawn on accounts of money services businesses, and to analyze such accounts and their associated transactions for suspicious activity. For example, computer system 101 may be specially programmed to implement the techniques described in more detail below.

Computer system 101 is supplied with an indication 103 of which accounts to investigate, for example a list of accounts, analyzes the accounts in light of information from databases 102, and produces a report 104 of its analysis.

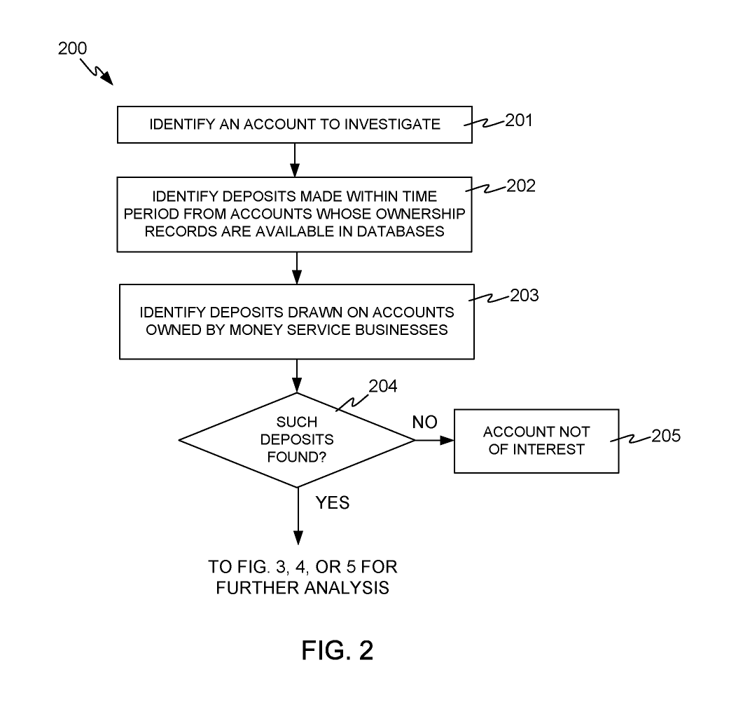

FIG. 2 illustrates a flow chart of a method 200 in accordance with embodiments of the invention for identifying records of an account for further investigation, including steps that may be performed by computer system 101. It will be recognized that method 200 (and the further analyses described below, when warranted) may be performed for a number of accounts, for example each account in a list of accounts to be investigated.

In step 201, an account of interest is identified for investigation. For example, a particular financial institution may supply a list of accounts to be investigated and a particular account to be investigated may be selected from the list, or the account to be investigated may be identified in some other way.

In step 202, databases 102 are searched for records of deposits made into the account identified in step 201, for which drawee account ownership records are available in databases 102, and which were made within a predetermined time period. For example, deposits made into the account within the past 14 days (or another suitable time period) may be investigated. For this purpose, a database having deposit records including drawee account numbers and other information may be accessed.

In step 203, deposits identified in step 202 are further filtered to identify deposits that were drawn on accounts identifiable as being owned by money service businesses. For example, a database having a table of accounts owned or otherwise associated with money service businesses and correlating the account numbers with the owners of the accounts may be accessed. If no such deposits are found as shown in step 204, then the account being investigated is not of interest for the techniques of this disclosure, as shown in step 205. (The account could still be of interest for other purposes.) If such deposits are found, then further analysis is performed.

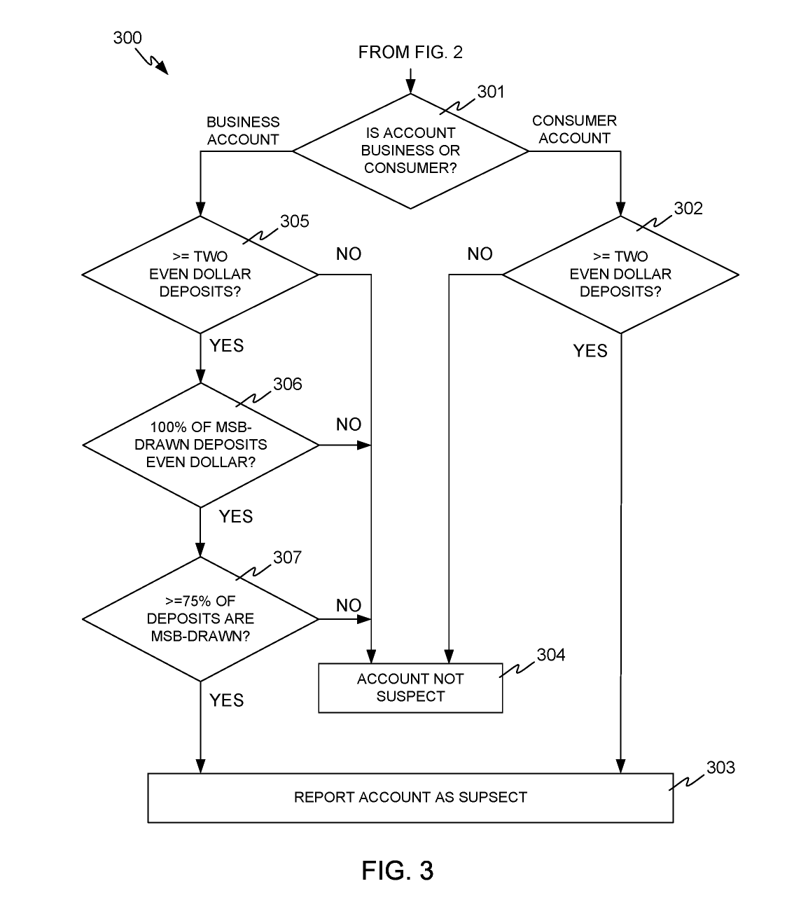

FIG. 3 illustrates a flow chart of a method 300 in accordance with embodiments of the invention, for further analysis of deposits identified in method 200 as having been made within the predetermined time period and drawn from accounts owned by money service businesses. In the example method of FIG. 3, patterns in the number and amounts of deposits are analyzed to identify accounts suspected of being used for money laundering.

In some embodiments, business accounts and consumer accounts may be analyzed using different criteria for deciding whether account activity is suspicious or not. For example, in step 301, it is determined whether the particular account being investigated is a business account or a consumer account. For a consumer account, deposit records for the account are analyzed in step 302 to determine if there have been at least two deposits received (within the time period of interest from accounts owned by money service businesses) that are in even (integer) dollar amounts, for example $700.00, $1501.00, $2322.00, or the like. Examples of amounts that are not even dollar amounts are $2376.25, $1087.92 and the like. In the example of FIG. 3, if there have been at least two even-dollar deposits into an account within the time period of interest drawn on accounts owned by money service businesses, then that account is flagged at step 303 as being suspect and this fact is reported. If not, then the account is not considered suspect, as shown at step 304. It will be recognized that the threshold of two for the number of identified deposits is but an example, and other thresholds may be used in other embodiments.

For an account that is identified as a business account, different or additional criteria may be applied. For example, in step 305, a test similar to step 302 may be applied, to determine whether the business account being investigated has received at least two even-dollar deposits within the time period of interest drawn on accounts owned by money service businesses. If not, the account is not considered as suspect, as shown in step 304.

However, if so, then the account is further analyzed in step 306 to determine if 100% of deposits received during the time period of interest from accounts owned by money service businesses were in even dollar amounts. In some embodiments, a threshold lower than 100% may be used. If not, the account is not considered as suspect, as shown in step 304.

However if so, then the account is still further analyzed in step 307 to determine if at least 75% (or another suitable portion) of the deposits to the account are drawn on accounts owned by money service businesses. If not, the account is not considered as suspect, as shown in step 304. However if so, then the account is flagged at step 303 as being suspect and this fact is reported.

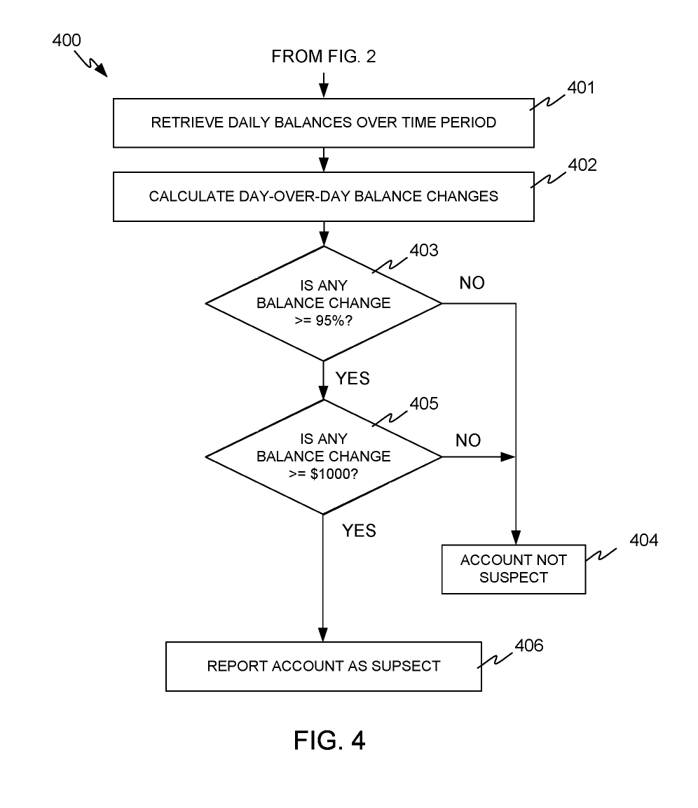

FIG. 4 illustrates a flow chart of a method 400 in accordance with other embodiments of the invention, for further analysis of deposits identified in method 200 as having been made within the predetermined time period and drawn from accounts owned by money service businesses. In the example method of FIG. 4, patterns in the timing and amounts of deposits and withdrawals are analyzed to identify accounts suspected of being used as funnel accounts for money laundering.

For example, in step 401, the daily balances over the time period of interest in the account being investigated are retrieved from databases 102.

In step 402, the percentage day-over-day change in the balance of the account is computed for each day interval in the time period of interest. In some embodiments, the percentage change in an account balance may be computed as

$$Balance \% change = \frac{\vert Balance Day 2 - Balance Day 1 \vert}{( Balance Day 1 )} \times 100$$

For example, if a particular account has a balance or $5000.00 on Day 1 and a balance of $1.00 on Day 2, the percentage change in the balance between Day 1 and Day 2 is 99.98%. In addition, the change in the principal balance is a $4999.00 reduction.

In step 403, the daily balance changes are investigated to see if any of them results in a change of 95% or more in the account balance. It will be recognized that the threshold of 95% is an example, and that other thresholds may be used. If no balance change of at least 95% is found, the account is not considered as suspect, as shown in step 404.

However if such a balance change is detected, the daily balance changes are further investigated in step 405 to determine if the balance in the account has changed by more than $1000.00 (or another suitable threshold amount) between any two days in the time period of interest. If not, the account is not considered as suspect, as shown in step 404.

However if so, the account is flagged at step 406 as being suspect and this fact is reported. The embodiment of FIG. 4 may be especially useful in detecting the gradual buildup of an account balance by a series of small deposits drawn on money services businesses, and then the abrupt withdrawal of all or nearly all of the balance of the account. Such a pattern of gradual deposits and sudden withdrawals may be a suspected precursor of especially trade based money laundering.

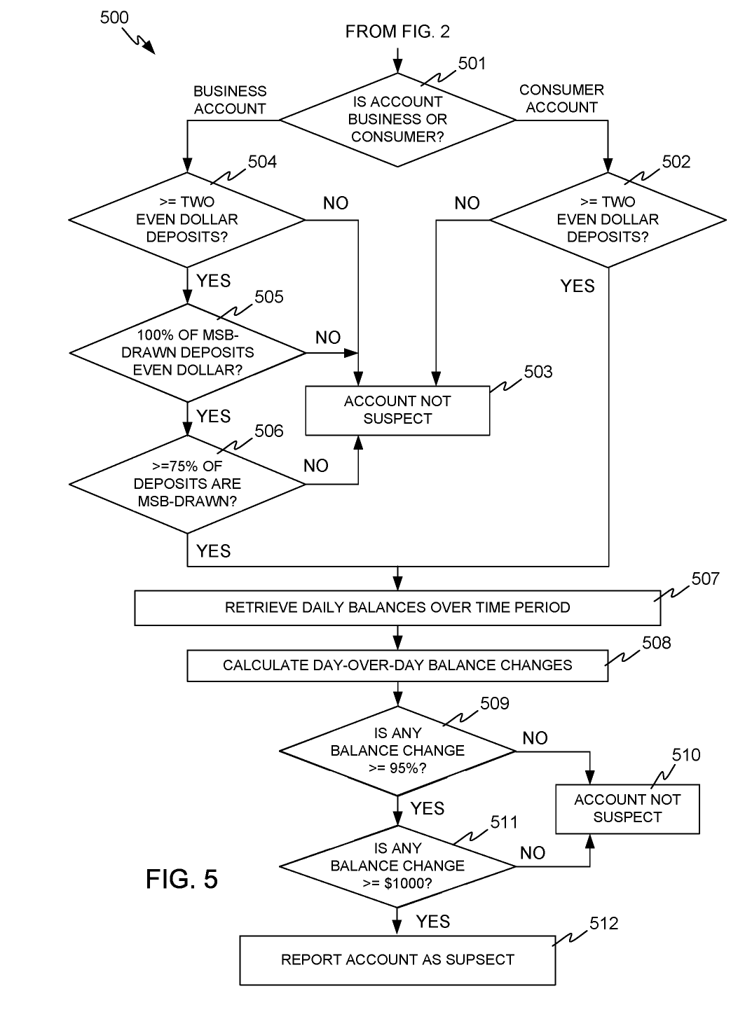

FIG. 5 illustrates a flow chart of a method 500 in accordance with other embodiments of the invention, for further analysis of deposits identified in method 200 as having been made within the predetermined time period and drawn from accounts owned by money service businesses. It will be recognized that method 500 combines methods 300 and 400 in series. Steps 501-506 correspond to steps 301, 302, and 304-307 shown in FIG. 3, and steps 507-512 correspond to steps 401-406 shown in FIG. 4. In the embodiment of FIG. 5, a consumer account is not categorized as suspect unless all of tests 502, 509, and 511 result in an answer of “YES”, and a business account is not categorized as suspect unless all of tests 504, 505, 506, 509, and 511 result in an answer of “YES”. Accordingly, an account classified as suspect using method 500 may carry an especially strong suspicion of being used for illicit activity.

In other embodiments, fewer than all of the steps of method 300, 400, or 500 may be performed, and in other embodiments, steps may be performed in a different order than is illustrated. The steps of methods such as methods 300, 400, or 500 may be repeated for a number of different accounts.

Once an account has been flagged as suspect, the account's owner may be identified by looking up the account in one of databases 102 containing account ownership records. Preferably, databases 102 contain account and transaction records from a number of different financial institutions, so that embodiments of the invention can detect suspected fraud across a number of different institutions.

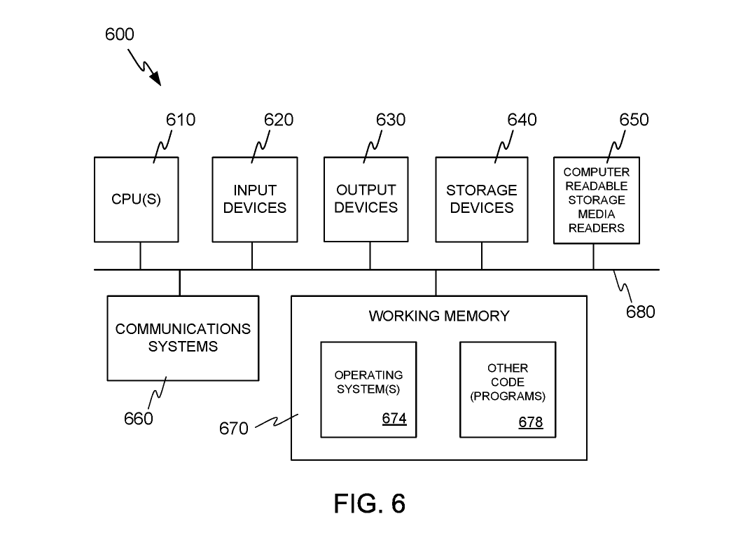

FIG. 6 is a block diagram illustrating an exemplary computer system 600 upon which embodiments of the present invention may be implemented. This example illustrates a computer system 600 such as may be used, in whole, in part, or with various modifications, to provide the functions of the system 100, as well as other components and functions of the invention described herein.

The computer system 600 is shown comprising hardware elements that may be electrically coupled via a bus 680. The hardware elements may include one or more central processing units 610, one or more input devices 620 (e.g., a mouse, a keyboard, etc.), and one or more output devices 630 (e.g., a display device, a printer, etc.). The computer system 600 may also include one or more storage devices 640, representing remote, local, fixed, and/or removable storage devices and storage media for temporarily and/or more permanently containing computer-readable information, and one or more storage media reader(s) 650 for accessing the storage device(s) 640. By way of example, storage device(s) 640 may be disk drives, optical storage devices, solid-state storage device such as a random access memory (“RAM”) and/or a read-only memory (“ROM”), which can be programmable, flash-updateable or the like.

The computer system 600 may additionally include a communications system 660 (e.g., a modem, a network card—wireless or wired, an infra-red communication device, a Bluetooth™ device, a near field communications (NFC) device, a cellular communication device, etc.) The communications system 660 may permit data to be exchanged with a network, system, computer, mobile device and/or other component as described earlier. The system 600 also includes working memory 670, which may include RAM and ROM devices as described above.

The computer system 600 may also comprise software elements, shown as being located within a working memory 670, including an operating system 674 and/or other code 678. Software code 678 may be used for implementing functions of various elements of the architecture as described herein. For example, software stored on and/or executed by a computer system, such as system 600, can be used in implementing the processes seen in FIGS. 2-5.

It should be appreciated that alternative embodiments of a computer system 600 may have numerous variations from that described above. For example, customized hardware might also be used and/or particular elements might be implemented in hardware, software (including portable software, such as applets), or both. Furthermore, there may be connection to other computing devices such as network input/output and data acquisition devices (not shown).

While various methods and processes described herein may be described with respect to particular structural and/or functional components for ease of description, methods of the invention are not limited to any particular structural and/or functional architecture but instead can be implemented on any suitable hardware, firmware, and/or software configuration. Similarly, while various functionalities are ascribed to certain individual system components, unless the context dictates otherwise, this functionality can be distributed or combined among various other system components in accordance with different embodiments of the invention. As one example, the system 100 system may be implemented by a single system having one or more storage device and processing elements.

Moreover, while the various flows and processes described herein (e.g., those illustrated in FIGS. 2-5) are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments may be described with (or without) certain features for ease of description and to illustrate exemplary features, the various components and/or features described herein with respect to a particular embodiment can be substituted, added, and/or subtracted to provide other embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A computerized system, comprising:
a processor; and
data storage, the data storage holding one or more databases records of a number of deposits into a number of accounts at a number of financial institutions, the records indicating for each of the number of deposits at least the number of an account from which funds were drawn to make the deposit, the number of an account into which the deposit was made, the amount of the deposit, and the date of the deposit;
wherein the system is specially programmed to:
identifying, from the records, accounts that received deposits of funds drawn from accounts associated with one or more money service businesses within a predetermined time period; and
for each identified account:
evaluate whether the deposits received into the account drawn from accounts associated with one or more money service businesses were in even dollar amounts;
evaluate the number of deposits in even dollar amounts received into the account within the predetermined time period; and
categorize the account as a suspected funnel account or not a suspected funnel account based at least in part on the evaluations;
wherein at least some of the identified accounts are categorized as suspected funnel accounts, and for at least each account categorized as a suspected funnel account, reporting the result of the categorization

2. A method, comprising:
maintaining one or more computerized databases holding records of a number of deposits into a number of accounts at a number of financial institutions, the records indicating for each of the number of deposits at least the number of an account from which funds were drawn to make the deposit, the number of an account into which the deposit was made, the amount of the deposit, and the date of the deposit;
identifying, from the records, accounts that received deposits of funds drawn from accounts associated with one or more money service businesses within a predetermined time period; and
for each identified account:
evaluating whether the deposits received into the account drawn from accounts associated with one or more money service businesses were in even dollar amounts;
evaluating the number of deposits in even dollar amounts received into the account within the predetermined time period; and
categorizing the account as a suspected funnel account or not a suspected funnel account based at least in part on the evaluations;
wherein at least some of the identified accounts are categorized as suspected funnel accounts, and for at least each account categorized as a suspected funnel account, reporting the result of the categorization.

3. The method of claim 2, further comprising:
determining whether each account is a business account or a consumer account, including determining that at least one of the accounts is a business account and that at least one of the accounts is a consumer account; and
using a first set of criteria for categorizing business accounts, and using a second set of criteria, different from the first, for categorizing consumer accounts.

4. The method of claim 2, wherein categorizing a particular account as a suspected funnel account or not a suspected funnel account further comprises categorizing the account as a suspected funnel account when the number of deposits into the account in even dollar amounts drawn from accounts associated with one or more money services businesses within the predetermined time period is above a first threshold.

5. The method of claim 4, further comprising:
evaluating the magnitude of any withdrawals from the account within the predetermined time period; and
categorizing the account as a suspected funnel account or not a suspected funnel account based at least in part on the magnitude of the withdrawals.

6. The method of claim 2, further comprising:
evaluating the magnitude of any withdrawals from the account within the predetermined time period; and
categorizing the account as a suspected funnel account or not a suspected funnel account based at least in part on the magnitude of the withdrawals.

7. The method of claim 6, wherein categorizing a particular account as a suspected funnel account or not a suspected funnel account further comprises categorizing the account as a suspected funnel account when:
the balance in the account has changed by more than a threshold percentage within the predetermined time period; and
the balance in the account has changed by more than a threshold amount between two consecutive days within the predetermined time period

8. The method of claim 2, wherein categorizing a particular account as a suspected funnel account or not a suspected funnel account further comprises categorizing the account as a suspected funnel account when:
the number of deposits into the account in even dollar amounts drawn from accounts associated with one or more money services businesses within the predetermined time period is above a first threshold;
the percentage of deposits into the account drawn from accounts associated with one or more money services businesses within the predetermined time period that are in even dollar amounts meets or exceeds a second threshold; and
the percentage of deposits into the account that are drawn from accounts associated with one or more money services businesses is above a third threshold.
